(19) United States
(12) Patent Application Publication
(10) Pub. No.: US 2019/0134880 A1
(43) Pub. Date: May 9, 2019

(54) SYSTEM AND PROCESS FOR VACUUM MOLDING

(71) Applicant: PERSICO S.P.A., Nembro (BG) (IT)

(72) Inventors: Romeo MAZZON, Nembro (BG) (IT); Marco SCARPELLINI, Nembro (BG) (IT)

(73) Assignee: PERSICO S.P.A., Nembro (BG) (IT)

(21) Appl. No.: 16/093,050

(22) PCT Filed: Mar. 24, 2017
(86) PCT No.: PCT/IT2017/000061

§ 371 Date: Oct. 11, 2018

(30) Foreign Application Priority Data
Apr. 15, 2016 (IT) UA2016A002593

(51) Int. Cl. B29C 51/06; B29C 51/00; B29C 51/26; B29C 51/08; B29C 51/10; B29C 51/14; B29C 51/30; B29C 51/42; B29C 37/00

(52) U.S. Cl. CPC B29C 51/06; B29C 51/002; B29C 51/262; B29C 51/082; B29C 51/10; B29C 51/14; B29K 2075/00; B29C 51/428; B29C 37/0075; B29C 2791/001; B29C 2791/006; B29K 2023/06; B29C 51/303

(57) ABSTRACT

A system is for making a molded article made of foamed material, including a die (1) composed of an upper section (11) and a lower section (12), separable and coupled to define a recess. A first suction (20) creates a vacuum to allow shaping a plastic film on the wall of a portion of the recess of the sections (11) and (12). A tensioner and lock (30) of the plastic film allow positioning and fastening the plastic film outside the recess.

The present invention refers to a system and a process for making a moulded article made of foamed material.

In general, the present invention refers to dies for forming plastic items subjected to the application of surface layers. For example, a coating applied on the surface of the die before inserting a molding material or composite, the coating being applied in a solid sheet and comprising separating or detaching agents.

In particular, the present invention refers to forming systems employing the internal pressure generated in the material. For example, forming of foam, items made of foamed plastics, items made of porous or cellular plastics, plastic materials, such as gommapiuma, elastomers, such as rubber.

In particular, the present invention refers to dies or cores with coatings, for example, of the enamel-coated or zinc-coated type, release coatings, such as oil or separating and detaching agents, such as sheets, laminati.

The state of the art is given by patent U.S. Pat. No. 5,728,333A dealing with a moulded item made of rigid polyurethane foam produced by using a die composed of an upper part and a lower part which are separable and adapted to be mutually coupled to define a recess between them. A film of polypropylene is previously taken under vacuum to be suited to the recess inside the die and fastened to the lower part of the die, outside the recess. A foam generating agent and rigid polyurethane are inserted in the recess and on the film, making the foam expand to model an item made of rigid foamed polyurethane. Afterwards, the moulded article is lifted with the film from the recess of the die by a pneumatic pressure or by an extractor. The moulded article is removed from the film.

Patent U.S. Pat. No. 5,728,333A allows providing a method for preparing a moulded article made of rigid foamed polyurethane using a die in combination with a film or plastic film, removing the additional passage of separating the moulded article from the plastic film, guaranteeing the early expulsion of the moulded article from the die, preventing the plastic film from deforming to allow re-using the plastic film, with advantages such as the reduction of the occupation time of the die, an increase of the number of molding press operations per unit of time and better productivity. The moulded article is removed from the film which, once lifted, is returned to its original shape.

Moreover, the state of the art is given by patent application DE201010032095A1, which deals with a process for producing a decorative part having a carrier layer, a layer of foam and a decorative layer. In particular, a supporting layer is placed in a first tool of a tool-holder device, a separating layer is placed inside a second tool of the tool-holder device, allowing to close the first and the second tool so that, between the separating layer and the carrier layer, a recess is at least partially formed. A layer of foam is injected in the recess included between the carrier layer and the separating layer through a foaming device, wherein the materials of the layer of foam and the separating layer are configured so that, between the separating layer and the layer of foam, a releasable connection is formed, when the two tools are separated, allowing to remove the carrier layer and the layer of foam. At the end of the process, the direct lamination of the layer of foam is performed with the decorative layer, after the separation of the movable connection between the release layer and the layer of foam.

The state of the art does not deal with operating problems when tensioning and the fastening of the plastic film used as separator and detaching agent of the moulded article with respect to the wall of the die.

Documents U.S. Pat. No. 1,387,617, US-A1-2001/018080, WO-A1-2007/128397, EP-A1-1 648 684 and U.S. Pat. No. 4,443,401 disclose systems according to the preamble of claim 1.

Object of the present invention is solving the above prior art problems by providing a system for making a moulded article made of foamed material including tensioning and locking means of detaching means such as a plastic film.

A further object is providing a process dealing with the use of such tensioning and locking means.

The above and other objects and advantages of the invention, as will appear from the following description, are obtained with a system for making a moulded article made of foamed material, as claimed in claim 1 and with a process for making a moulded article made of foamed material, as claimed in claim 9. Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) can be made to what is described, without departing from the scope of the invention as appears from the enclosed claims.

The present invention will be better described by some preferred embodiments thereof, provided as a non-limiting example, with reference to the enclosed drawings, in which:

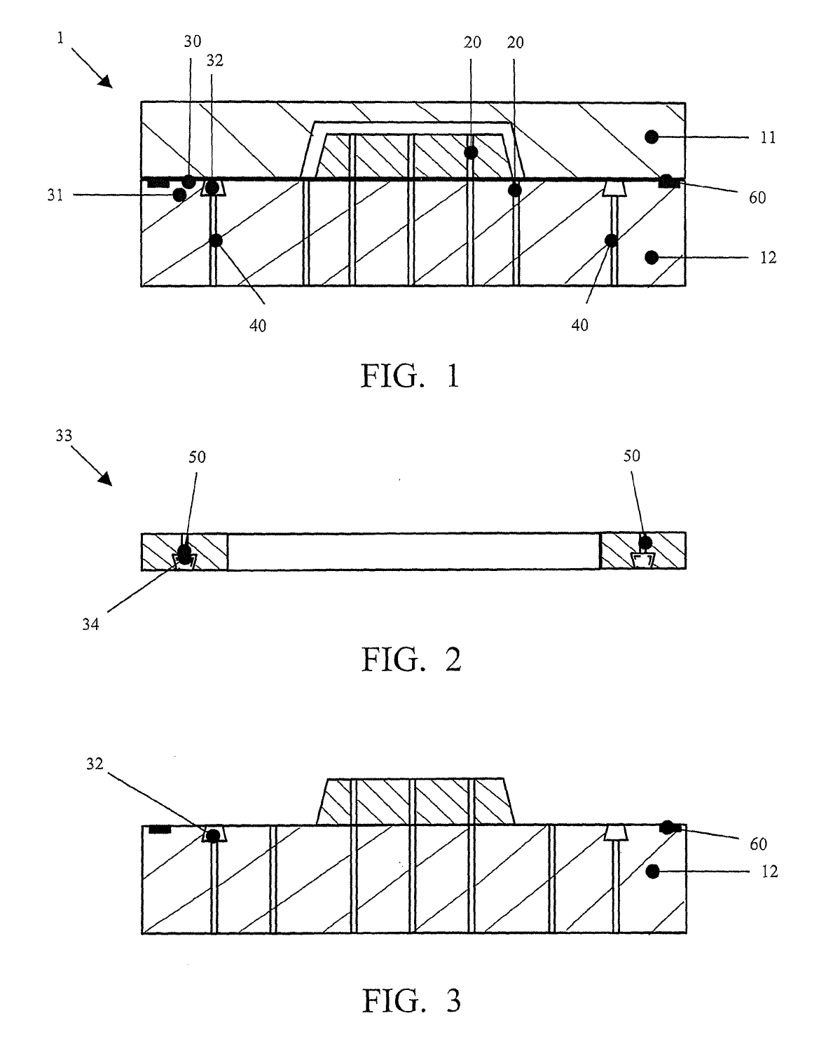

FIG. 1 shows a die essentially composed of two sections of an embodiment of the system for making a moulded article made of foamed material, according to the present invention;

FIG. 2 shows a component of an embodiment of the system for making a moulded article made of foamed material, according to the present invention;

FIG. 3 shows one of the two sections of FIG. 1;

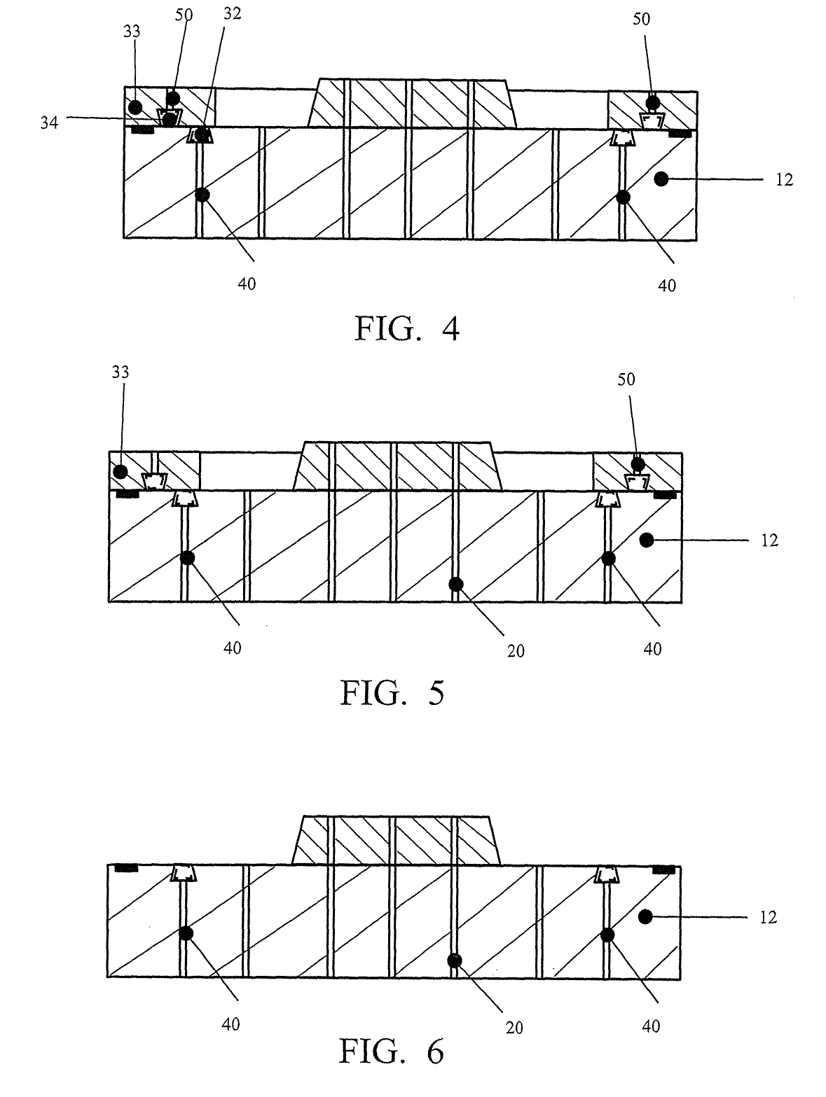

FIG. 4 shows a first configuration made through the composition of FIGS. 2, 3;

FIG. 5 shows a second configuration made through the composition of FIGS. 2, 3; and

FIG. 6 shows a final configuration of FIG. 3.

With reference to FIG. 1, it is possible to note that a system for making a moulded article made of foamed material comprises a die 1 essentially composed of sections, respectively an upper section 11 and a lower section 12, which are separable and coupled to define a recess, first sucking means 20 adapted to create a vacuum to allow shaping a plastic film on the wall of at least one portion of the recess of sections 11 and 12, tensioning and locking means 30 of the plastic film to allow positioning and fastening the plastic film outside the recess, injecting means of foamed raw material, in contact with the plastic film to allow the foamed raw material to be expanded in the recess in order to model the moulded article made of rigid foamed material, means for expelling the moulded article and the plastic film and means for detaching the moulded article with respect to the plastic film.

Advantageously, such tensioning and locking means 30 of the plastic film comprise a fixed frame 31 equipped with at least one internal perimeter groove 32. In particular, the internal groove 32 is peripherally arranged with respect to the recess of the sections 11 and 12 and connected to second sucking means 40 to create a vacuum adapted to allow tensioning and blocking the plastic film along the internal groove 32. Moreover, the fixed frame 31 lays integrally with at least one of the sections 11 and 12, next to a deformable peripheral gasket 60. The deformable gasket 60 allows air-tightly insulating the recess of the sections 11 and 12.

With reference to FIG. 3, such tensioning and locking means 30 of the plastic film comprise a mobile frame 33 equipped with at least one external perimeter groove 34. The external groove 34 is peripherally arranged with respect to the internal groove 32 and connected to third sucking means 50 adapted to create a vacuum to allow tensioning and blocking the plastic film along the external groove 34.

With reference to FIG. 3, 4, 5, the mobile frame 33 is mechanically joined with at least one of the sections 11 and 12; in the figure section 12 is shown, to allow positioning the plastic film with respect to the uncoupled sections 11 and 12, before closing the die 1.

In particular, the mobile frame 33, mechanically joined to at least one of the sections 11 and 12, presses on the deformable peripheral gasket 60. In this configuration, shown in FIGS. 4 and 5, the deformable gasket 60 is in contact with one of the sections 11 and 12 and with the plastic film.

According to a preferred configuration, the perimeter internal groove 32, 34 is shaped as an undercut to increase the wet perimeter of the internal groove 32, 34 to allow increasing the sliding of the plastic film along the wet perimeter of the internal groove 32, 34, thereby increasing the tensioning and the locking of the plastic film.

The first, second and third sucking means 20, 40, 50 comprise filtering elements adapted to allow distributing the suction action and level the vacuum action, in the recess formed of the coupled sections 11, 12 and in the internal groove 32, 34. Preferably, such filtering elements are made of porous material, of a cylindrical shape and placed in cylindrical seats belonging to the first, second and third sucking means 20, 40, 50.

A process for making a moulded article made of foamed material comprises the following steps, for positioning and tensioning of the plastic film:
a) positioning the stretched plastic film on the mobile frame 33, FIG. 2;
b) activating the third sucking means 50 to create the vacuum to allow tensioning and blocking the plastic film with respect to the mobile frame 33, along the perimeter of the external groove 34;
c) positioning the mobile frame 33 with respect to one of the sections 11 and 12 to allow mechanically joining the mobile frame 33 to at least one of the sections 11 and 12, FIG. 4;
d) activating the second sucking means 40 to create the vacuum to allow further tensioning and blocking the plastic film, also with respect to the fixed frame 31, along the perimeter of the external groove 32;
e) activating the first sucking means 20 to create the vacuum to allow adhering the plastic film to the portion of recess delimited by at least one of said sections 11 and 12, FIG. 5;
f) deactivating the third sucking means 50 to allow separating the plastic film from the mobile frame 33 and to allow mechanically separating the mobile frame 33 with respect to one of the sections 11, 12, FIG. 6;
g) starting the moulding procedure by joining the sections 11, 12 of the die 1, FIG. 1.

The system of the present invention and its related process allow obtaining the stated objects.

In particular, the system of the invention is suitable for forming a skin product fastened onto the foamed surface through pre-fixing and then compressed through press-covering. The technologic field of application of such system deals with automotive, interiors and dashboards.

Preferably, the plastic film is made of polyethylene, which is used as detaching agent between the polyurethane foam and the die for the foamed product, before passing to the pre-fixing step, in which the skin is fastened onto the foamed surface and then subjected to press-covering.

The film has a thickness of 40:80 micron. The filters for diffusing the vacuum action are of the same type of cigarette filters and are suitable to avoid damaging the die in case of break of the plastic film, with following foam pollution in the vacuum channel.

The die is heated, allowing to easily detach the foam from the protective layer of the plastic film.

One of the advantages of the present invention is that the film allows replacing the fluid detaching agent, of the lubricating oil type.

Moreover, moulding of the foamed piece is performed without interposing a detaching agent.

1. System for making a moulded article made of foamed material, comprising a die including an upper section and a lower section, which are separable and coupled to define a recess, first sucking means adapted to create a vacuum to shape a plastic film on a wall of at least one portion of the recess of said sections, tensioning and locking means of the plastic film to position and fasten the plastic film outside the recess, said tensioning and locking means of the plastic film comprising a fixed frame equipped with at least one internal groove, said at least one internal groove being peripherally arranged with respect to the recess of said sections and connected to second sucking means to create a vacuum adapted to tension and block the plastic film along said at least one internal groove, wherein said first and second sucking means comprise filtering elements adapted to distribute suction action and levelling vacuum action, in the recess formed of said coupled sections and in said internal groove.

2. System for making a moulded article made of foamed material according to claim 1, wherein said fixed frame lays integrally with at least one of said sections, next to a deformable peripheral gasket, said deformable gasket adapted to air-tightly insulate the recess of said section.

3. System for making a moulded article made of foamed material according to claim 2, wherein said tensioning and locking means of the plastic film comprise a mobile frame equipped with at least one external groove, said at least one external groove being peripherally arranged with respect to said at least one internal groove and connected to third sucking means adapted to create a vacuum to tension and block the plastic film along said at least one external groove.

4. System for making a moulded article made of foamed material according to claim 3, wherein said mobile frame is mechanically joined to at least one of said sections, to position the plastic film with respect to said uncoupled sections, before closing said die.

5. System for making a moulded article made of foamed material according to claim 4, wherein said mobile frame mechanically joined to at least one of said sections, presses onto said deformable peripheral gasket, said deformable gasket adapted to air-tightly insulate the recess delimited by one of said sections and by the plastic film.

6. System for making a moulded article made of foamed material according to claim 1, wherein said at least one internal groove is shaped as an undercut to increase a wet perimeter of said at least one internal groove to increase sliding of the plastic film along the wet perimeter of said at least one internal groove, thereby increasing the tensioning and the locking of the plastic film.

7. System for making a moulded article made of foamed material according to claim 3, wherein said third sucking means comprise filtering elements adapted to distribute the suction action and levelling the vacuum action, in the recess formed of said coupled sections and in said internal groove.

8. System for making a moulded article made of foamed material according to claim 7, wherein the filtering elements are made of porous material, of a cylindrical shape and placed in cylindrical seats belonging to said first, second and third sucking means.

9. Process for making a moulded article made of foamed material through a system according to claim 3, comprising the following steps for positioning and tensioning of the plastic film:
a) positioning the stretched plastic film on the mobile frame;
b) activating the third sucking means to create the vacuum to tension and block the plastic film with respect to the mobile frame, along the perimeter of the external groove;
c) positioning the mobile frame with respect to one of said sections to mechanically join the mobile frame to at least one of said sections;
d) activating the second sucking means to create the vacuum to further tension and block the plastic film, with respect to the fixed frame, along the perimeter of the external groove;
e) activating the first sucking means to create the vacuum to adhere the plastic film to the portion of recess delimited by at least one of said sections;
f) deactivating the third sucking means to separate the plastic film from the mobile frame and to mechanically separate the mobile frame with respect to one of said sections;
g) starting the moulding procedure by joining the sections of the die.
